(19) United States
(12) Patent Application Publication
(10) Pub. No.: US 2016/0026931 A1
(43) Pub. Date: Jan. 28, 2016

(54) System and Method for Providing a Machine Learning Re-Training Trigger

(71) Applicant: Christopher Tambos, New York, NY (US)

(72) Inventor: Christopher Tambos, New York, NY (US)

(21) Appl. No.: 14/724,536

(22) Filed: May 28, 2015

Related U.S. Application Data
(60) Provisional application No. 62/003,752, filed on May 28, 2014.

(51) Int. Cl. G06N 99/00

(52) U.S. Cl. CPC G06N 99/005

(57) ABSTRACT

A system and method that records the important words lists according to a previous naive Bayes classifier for each category. If a new document provides different important words to distinguish the category from other categories, the method would then re-train the system. If the new document provides the same important words as the related important words list, the method would not re-train the system. When there are new training examples, the method must re-train the system. If the training examples come into the system one by one, the method must re-train the system again and again. Two re-training policies are taught to make the system of the present invention more effective and keep it up to date. The first policy is to regularly re-train the system everyday with all training examples. The second policy is to re-train in real time, during intervals each day.

### CROSS REFERENCE TO RELATED APPLICATIONS:

This application claims priority from U.S. Patent Application Ser. No. 62/003,752, entitled “System and Method for Providing a Machine Learning Re-Training Trigger”, filed on May 28, 2014. The benefit under 35 USC §119(e) of the United States provisional application is hereby claimed, and the aforementioned application is hereby incorporated herein by reference.

### TECHNICAL FIELD OF THE INVENTION

The present invention pertains to generally to a machine learning system. The present invention more specifically relates to an automated sizing of a data set for training a machine learning system.

### BACKGROUND OF THE INVENTION

In the current state of the art, one must re-train machine learning systems whenever there are new training examples. It is more desirable to re-train only when the new training examples could provide extra information. This would minimize the amount of re-training processes and keep a system up to date at the same time.

Unless stated to the contrary, for the purposes of the present disclosure, the following terms shall have the following definitions:

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become very popular and in 2010 was listed as “Word of the Year” by the American Dialect Society

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“API” In computer programming, an application programming interface (API) is a set of routines, protocols, and tools for building software applications. An API expresses a software component in terms of its operations, inputs, outputs, and underlying types. An API defines functionalities that are independent of their respective implementations, which allows definitions and implementations to vary without compromising each other.

“Email” or “electronic messages” is defined as a means or system for transmitting messages electronically as between computers or mobile electronic devices on a network.

“Email Client” or more formally mail user agent (MUA) is a computer program used to access and manage a user's email. A web application that provides message management, composition, and reception functions is sometimes also considered an email client, but more commonly referred to as webmail.

“EMS” is an abbreviation for email service providers, which are companies that provide email clients enabling users to send and receive electronic messages. “Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and table PCs.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard. The Hypertext Transfer Protocol (HTTP) is an application protocol for distributed, collaborative, hypermedia information systems.[1] HTTP is the foundation of data communication for the World Wide Web. Hypertext is structured text that uses logical links (hyperlinks) between nodes containing text. HTTP is the protocol to exchange or transfer hypertext.

The Internet Protocol (IP) is the principal communications protocol in the Internet protocol suite for relaying datagrams across network boundaries. Its routing function enables internetworking, and essentially establishes the Internet.

An Internet Protocol address (IP address) is a numerical label assigned to each device (e.g., computer, printer) participating in a computer network that uses the Internet Protocol for communication. An IP address serves two principal functions: host or network interface identification and location addressing.

An Internet service provider (ISP) is an organization that provides services for accessing, using, or participating in the Internet.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “mobile device” is a generic term used to refer to a variety of devices that allow people to access data and information from where ever they are. This includes cell phones and other portable devices such as, but not limited to, PDAs, Pads, smartphones, and laptop computers.

A “module” in software is a part of a program. Programs are composed of one or more independently developed modules that are not combined until the program is linked. A single module can contain one or several routines or steps.

A “module” in hardware, is a self-contained component.

“REC” or “recipient email client” is the computer program used to access and manage a user's email when that user is the recipient of the email being tracked or monitored.

“RTS” or “remote tracking server” is a third party software module stored on and executed by a computer that communicates with a recipient email client to gather information about specific emails being received.

A “software application” is a program or group of programs designed for end users. Application software can be divided into two general classes: systems software and applications software. Systems software consists of low-level programs that interact with the computer at a very basic level. This includes operating systems, compilers, and utilities for managing computer resources. In contrast, applications software (also called end-user programs) includes database programs, word processors, and spreadsheets. Figuratively speaking, applications software sits on top of systems software because it is unable to run without the operating system and system utilities.

A “software module” is a file that contains instructions. “Module” implies a single executable file that is only a part of the application, such as a DLL. When referring to an entire program, the terms “application” and “software program” are typically used. A software module is defined as a series of process steps stored in an electronic memory of an electronic device and executed by the processor of an electronic device such as a computer, pad, smart phone, or other equivalent device known in the prior art.

A “software application module” is a program or group of programs designed for end users that contains one or more files that contains instructions to be executed by a computer or other equivalent device.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio (e.g. LTE), Wi-Fi, 3rd-party apps, motion sensor and mobile payment.

URL is an abbreviation of Uniform Resource Locator (URL), it is the global address of documents and other resources on the World Wide Web (also referred to as the “Internet”).

A “User” is any person registered to use the computer system executing the method of the present invention.

In computing, a “user agent” or “useragent” is software (a software agent) that is acting on behalf of a user. For example, an email reader is a mail user agent, and in the Session Initiation Protocol (SIP), the term user agent refers to both end points of a communications session. In many cases, a user agent acts as a client in a network protocol used in communications within a client-server distributed computing system. In particular, the Hypertext Transfer Protocol (HTTP) identifies the client software originating the request, using a “User-Agent” header, even when the client is not operated by a user. The SIP protocol (based on HTTP) followed this usage.

A “web application” or “web app” is any application software that runs in a web browser and is created in a browser-supported programming language (such as the combination of JavaScript, HTML and CSS) and relies on a web browser to render the application.

A “website”, also written as Web site, web site, or simply site, is a collection of related web pages containing images, videos or other digital assets. A website is hosted on at least one web server, accessible via a network such as the Internet or a private local area network through an Internet address known as a Uniform Resource Locator (URL). All publicly accessible websites collectively constitute the World Wide Web.

A “web page”, also written as webpage is a document, typically written in plain text interspersed with formatting instructions of Hypertext Markup Language (HTML, XHTML). A web page may incorporate elements from other websites with suitable markup anchors.

Web pages are accessed and transported with the Hypertext Transfer Protocol (HTTP), which may optionally employ encryption (HTTP Secure, HTTPS) to provide security and privacy for the user of the web page content. The user's application, often a web browser displayed on a computer, renders the page content according to its HTML markup instructions onto a display terminal. The pages of a website can usually be accessed from a simple Uniform

Resource Locator (URL) called the homepage. The URLs of the pages organize them into a hierarchy, although hyperlinking between them conveys the reader's perceived site structure and guides the reader's navigation of the site.

### SUMMARY OF THE INVENTION

The method of the present invention is where the system records the important words lists according to a previous naive Bayes classifier for each category. If a new document provides different important words to distinguish the category from other categories, the method would then re-train the system. If the new document provides the same important words as the related important words list, the method would not re-train the system. For Example, if, based on a basic train set, it was found that “invest” is a good feature to classify “class 1”. For one new training document, the method would not need to re-train the system in real time if this document belongs to “class 1” and again provide evidence that “invest” is a powerful feature.

When there are new training examples, the method must re-train the system. If the training examples come into the system one by one, the method must re-train the system again and again. Therefore, the present invention teaches a method that will use two re-training policies to make the system of the present invention more effective and keep it up to date. The first policy is to regularly re-train the system everyday with all training examples. The second policy is to re-train in real time, during intervals each day.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a Venn diagram for represents overlapping counts among three categories; and

FIG. 2 is a detailed Venn diagram of words;

FIG. 3 is the selected features for each category in one example of the present invention; and

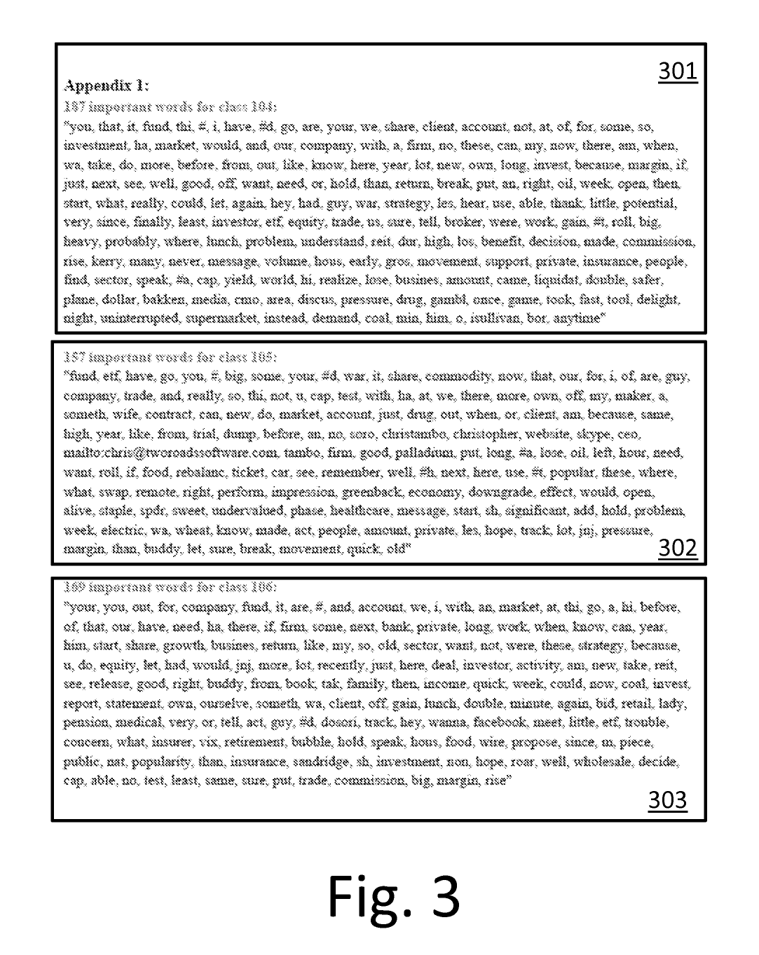

FIG. 4 is the result of new.train in one example of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

The physical apparatus required to enable one embodiment of the present invention includes a web server; a web portal interface; a multi-user network; and an application server. Thus, the method of the present invention may also be recorded onto a CD, or any other recordable medium as well as being delivered electronically from a database to a computer, wherein the method embodied by the software that is recorded is then executed by a computer for use and transformation of the Internet browser and its contents. Now referring to the Figures, the embodiment of the method of the present invention is shown.

When there are new training examples, the method must re-train the system. If the training examples come into the system one by one, the method must re-train the system again and again. Therefore, the present invention teaches a method that will use two re-training policies to make the system of the present invention more effective and keep it up to date. The first policy is to regularly re-train the system everyday with all training examples. The second policy is to re-train in real time, during intervals each day.

Regular re-train (with all the training examples), for example, could re-train the system every day with all training examples. Or once the system has a certain amount of new training examples.

Real-time re-train (with new training examples) occurs during the intervals of each day, the system could re-train the system only when the system has new training examples that could provide extra information.

In one embodiment, the system will talk about real-time re-training process. The system will use the dataset “20140320_{—}1713_trainingData.txt” to give an example.

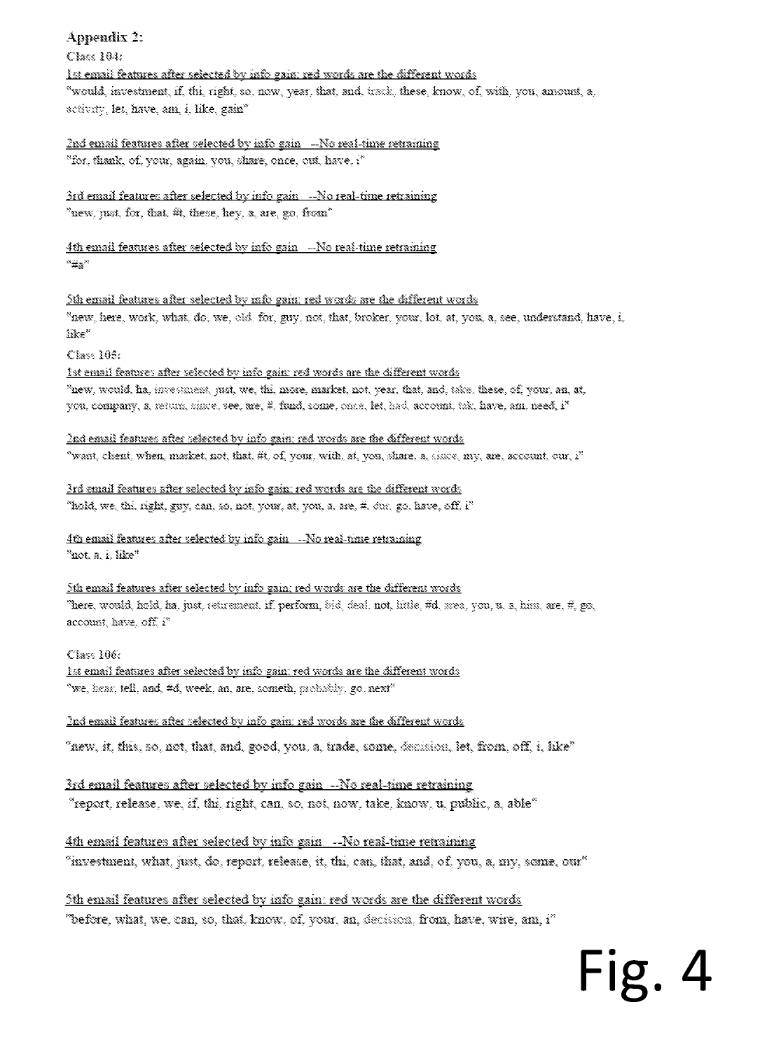

This dataset has 233 emails and 3276 features. Each email has a category label. And there are 3 categories in total, “104”, “105”, and “106”. Each feature is the TFIDF value of the term. Class 104 has 97 examples. The method uses 1:5 emails as the new training examples and 6:97 emails as the basic train set. In this example shown in FIG. 4, the inventor(s) left five emails as new training at here, but tested them separately in the final section. Class 105 has 63 examples. Also the method used 1:5 emails as a new train and 5:63 emails as basic train. Class 106 has 73 examples and five emails as a new train. The method then combines the three basic training sest and renames them as basic.train. So the basic.train set has 218 emails. The method then combined the three new training sets and names them as new.train. So the new.train set has 15 emails and each category has 5 emails.

In a first step, using the basic.train set, the method calculates information gain for each feature. Then selects the top features as new features. Before filtering with information gain, the method will have 3276 features in total. Next the method selects a threshold and drops those features with less information gain. Now the method has 283 features. Also the method keeps a dictionary of deleted features. With the basic.train set, a train naive bayes classifier uses the selected features.

The algorithm is at here. During your training algorithm, please keep the values of p(ti|Ck) (or the logarithm format). This value is the importance of word ti in category Ck.

After training, for each category, only select the features with p(ti|Ck)>0. So the method has 214 nonzero importance features for class “104”. 200 nonzero, importance features for class “105”. 210 nonzero importance features for class “106”.

As an option, the method filters all the features again based on their importance. The method can select threshold and only select the features with p(ti|Ck)>threshold>0. So the method has 187 important features for class “104”. 157 important features for class “105”. 169 important features for class “106”.

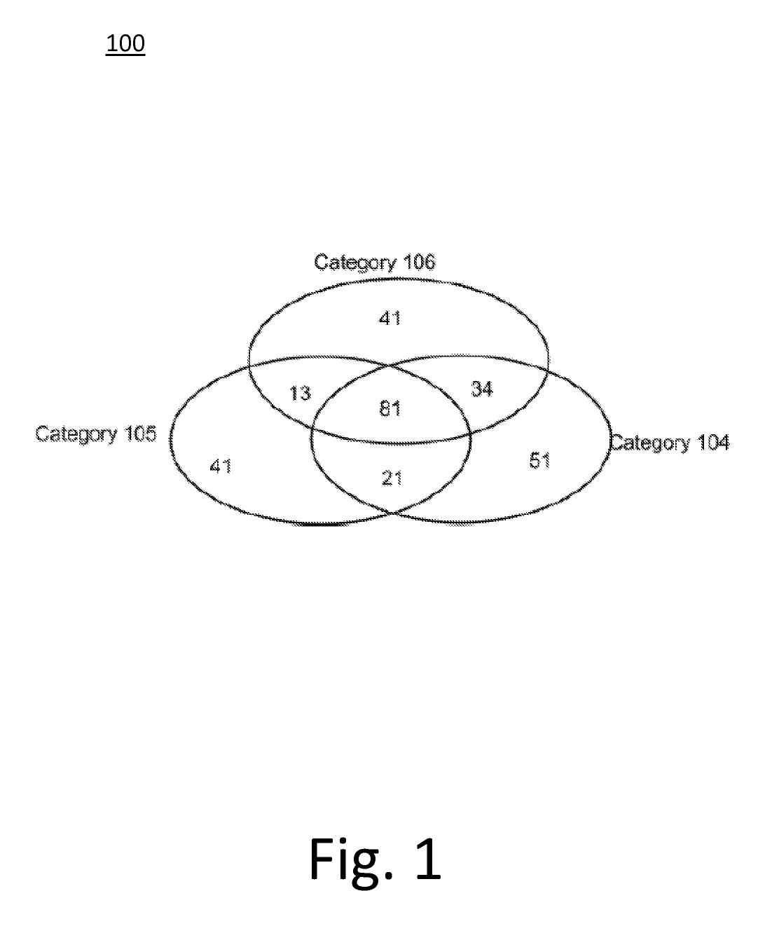

FIG. 1 is a Venn diagram 100 showing the results of one embodiment of the present invention. There are 81 shared important words for all three categories 201, 202, and 203. Class “104” 201 has 51 unique important words 301. Class “105” 202 has 42 unique important words 302. Class “106” 203 has 41 unique important words 303. FIG. 1's Venn diagram represents overlapping word counts among three categories 201, 202, and 203.

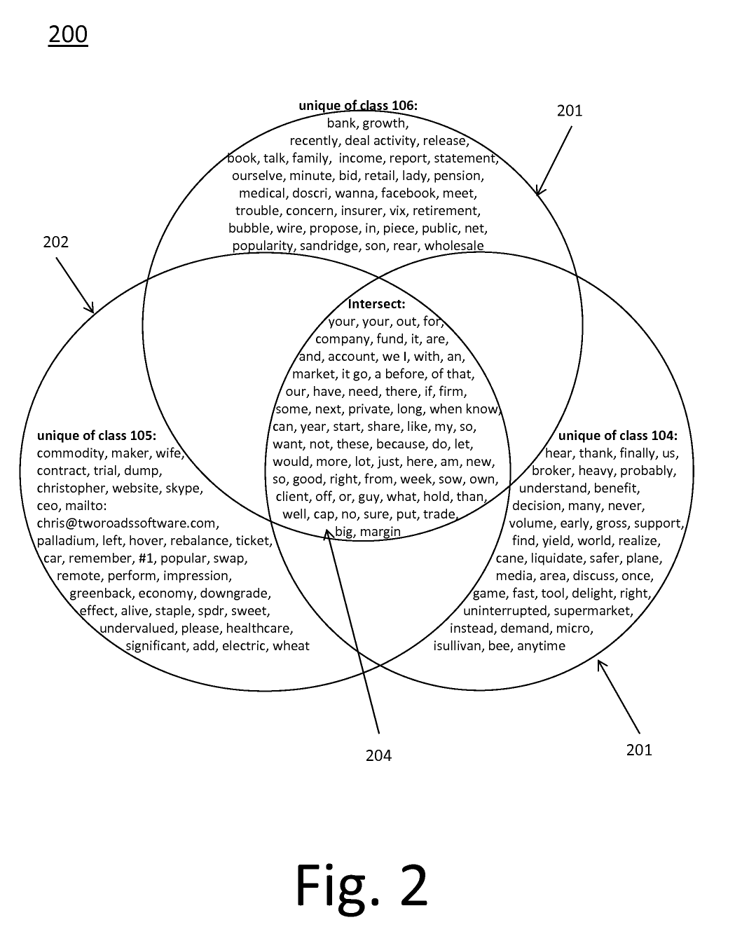

FIG. 2 is the detailed Venn diagram 200 showing the feature words. The diagram only illustrates the shared features 204 and unique features 201, 202, and 203 of each category. With a new.train set, filtered features according to previous information gain deleted words dictionary. And for each email, select features with nonzero TFIDF values. After filtering by previous information gain deleted words dictionary, the new.train has 15 rows and 283 columns. For each email, the remaining 283 features have a lot of zero TFIDF values. Next the method deletes all those features again. Now each email has a different number of features as shown in FIG. 4.

Since new.train is still a training data, the system has category labels. For each email, match the selected features with the important words list of the same category. If all the selected features are in the word list, the method keeps this email for regular training and the system will not trigger the real-time re-training If some of the selected features are not in the word list, the method triggers the real-time re-training process and also keep this email for regular training

The method taught by the present invention is set to run and/or executed on one or more computing devices. A computing device on which the present invention can run would be comprised of a CPU, hard disk drive, keyboard or other input means, monitor or other display means, CPU main memory or cloud memory, and a portion of main memory where the system resides and executes. Any general-purpose computer, tablet, smartphone, or equivalent device with an appropriate amount of storage space, display, and input is suitable for this purpose. Computer devices like this are well known in the art and are not pertinent to the invention.

In alternative embodiments, the method of the present invention can also be written or fixed in a number of different computer languages and run on a number of different operating systems and platforms.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method for machine learning retraining trigger executable by a machine and rendered on the display of the machine, comprising the steps of:
calculating information gain from one or more features;
selecting a threshold;
dropping those features with a information gain below the selected threshold;
selecting a feature as a new feature; and
filtering with selected new feature.

2. The method of claim 1, further comprising a dictionary of deleted features.

3. The method of claim 2, further comprising the steps of:
filtering features according to previous information gained based on the deleted words dictionary;
creating a new dataset file;
repeating the steps of:
calculating information gain from one or more features;
selecting a threshold;
dropping those features with a information gain below the selected threshold;
selecting a feature as a new feature; and
filtering with selected new feature.

3. The method of claim 2, further comprising the steps of:
creating category labels; and
matching selected features with an important words list of the same category for an email.

4. The method of claim 3, further comprising the step of:
keeping the email for regular training if all the selected features are in the word list.

5. The method of claim 3, further comprising the steps of:
triggering a real-time retraining process if one or more of the selected features are not in the word list; and
keeping the email for regular training.

5. The method of claim 3, further comprising the step of:
executing the method on a daily basis.

6. The method of claim 5, wherein regular training retrains the computer system using the method steps on a daily basis.

7. The method of claim 3, further comprising the steps of:
setting one or more interval periods for executing the method on a daily basis; and
executing the method one or more times on a daily basis.

8. The method of claim 3, wherein real-time training retrains the computer system using the method steps during one or more set intervals on a daily basis.
